(19) United States
(12) Patent Application Publication
(10) Pub. No.: US 2008/0200244 A1
(43) Pub. Date: Aug. 21, 2008

(54) Game collectibles

(75) Inventors: Richard E. Rowe, Las Vegas, NV (US); Thomas J. Matthews, Las Vegas, NV (US); Diana Goodsell, Henderson, NV (US); Pat Lee Flint, Las Vegas, NV (US); Gene Gohring, Las Vegas, NV (US); Lisa Ann Jemming, Las Vegas, NV (US); Michael Preisach, Las Vegas, NV (US); Caryn Cleerman, North Las Vegas, NV (US)

Correspondence Address: BEYER WEAVER LLP, P.O. BOX 70250, OAKLAND, CA, 94612-0250, US

(73) Assignee: IGT

(21) Appl. No.: 11/709,433

(22) Filed: Feb. 21, 2007

(51) Int. Cl. G06F 17/00

(52) U.S. Cl. 463/27

(57) ABSTRACT

Some implementations of the invention allow patrons to earn a “collectible” during the course of playing a wagering game. A collectible (and/or a hierarchy of collectibles) may be associated with a particular casino. While playing a game, a player may have options to redeem one or more collectibles. In some such implementations, a collectible may activate special game features, such as a special bonus round, a higher paytable for a defined period of time, or other features described in detail herein. A collectible may persist after a gaming session is completed. Some implementations of the invention provide persistent collectibles only for patrons who are members of a player loyalty program. However, other implementations of the invention provide persistent collectibles even for patrons who are not members of a player loyalty program.

### FIELD OF THE INVENTION

The present disclosure relates to devices, methods and networks involving wagering games.

### BACKGROUND OF THE INVENTION

Gaming establishments are continually searching for new and innovative techniques to increase player patronage and profits, and to improve operations. (Although there are many types of gaming establishments, including casinos, cruise ships, riverboats, etc., all types of gaming establishments may sometimes be referred to herein as “casinos.” Moreover, the term “casino” may be used to mean a particular gaming establishment, a group of associated gaming establishments and/or an entity that owns one or more gaming establishments.) A casino typically spends a great deal of time, money and effort in creating an attractive, exciting and distinctive environment. Marketing efforts may focus on both gaming and non-gaming features of the casino environment, the latter of which typically include entertainment venues, bars, restaurants, retail establishments, etc.

In recent years, player loyalty programs (including but not limited to player tracking programs) have become important aspects of casino operations and marketing. Player loyalty programs provide rewards to players that typically correspond to the player's level of patronage, e.g., to the player's playing frequency and/or total amount of game plays at a given casino. Player loyalty rewards may include free meals, free lodging and/or free entertainment. Some such complimentary rewards are often referred to as “comps.” Player loyalty rewards may help to sustain a game player's interest in additional game play during a visit to a gaming establishment and may entice a player to visit a gaming establishment to partake in various gaming activities.

Player loyalty programs can also provide many benefits to a casino. For example, player loyalty programs allow a casino to identify and reward customers based upon their previous game play history. In particular, a casino may identify, and provide a higher level of service to, certain groups of players identified as especially valuable to the casinos. Accordingly, player loyalty programs can be used to gather valuable information that may be used for marketing and to provide better customer services.

Another potential benefit of player loyalty programs is to increase “brand” loyalty. After a player has accumulated a significant number of points in a casino's player loyalty program, the player may be entitled to a higher level of comps, services, etc. Therefore, a player may be more likely to patronize that casino instead of another casino.

Although current casino player loyalty, marketing and “branding” methods are adequate, it would be desirable to provide more versatile methods and devices.

### SUMMARY OF THE INVENTION

Some implementations of the invention allow patrons to earn what will be referred to herein as a “collectible” (or sometimes as a “virtual token” or the like) during the course of playing a wagering game. Collectibles may be themed in various ways, e.g., to match a game type, a game theme, a gaming establishment or entity, an event and/or a customer preference. In alternative implementations, collectibles may be awarded for non-gaming activities, e.g., for patronizing a non-gaming venue of a casino, as part of a promotion and/or special event, etc.

In some implementations, a collectible may be redeemed for game play only, e.g., to enter into a special bonus round of a game, to activate a better paytable for a defined period of time, etc. However, in alternative implementations collectibles may be redeemed for points and/or comps. Preferably, collectibles have a number of configuration options that will determine the manner in which they may be awarded and redeemed.

A collectible may or may not persist after a gaming session is completed. Collectibles that persist after a gaming session is completed will sometimes be referred to herein as “persistent” collectibles or the like. Some implementations of the invention provide persistent collectibles only for patrons who are members of a player loyalty program. However, other implementations of the invention provide persistent collectibles even for patrons who are not members of a player loyalty program.

Some embodiments of the invention provide a gaming machine that includes the following elements: one or more peripheral devices for providing a wagering game; an interface configured for receiving a data structure comprising image data; and a logic system. The logic system may include one or more processors. The logic system is configured to extract the image data and associate the image data with virtual tokens. The logic system may be configured to control one or more peripheral devices to perform the following tasks: provide a wagering game; award one or more virtual tokens upon an occurrence of an event during the wagering game; and offer to redeem one or more virtual tokens in exchange for an opportunity involving the wagering game. The image data may be associated with a gaming establishment. The logic system may or may not cause the virtual token to persist after a gaming session.

The logic system may be configured to determine whether a player is a member of a player loyalty program. If so, the logic system may be configured to cause a virtual token assigned to a member of a player loyalty program to persist after a gaming session. In some embodiments, the gaming machine includes a player tracking device configured for associating the virtual token with a player loyalty account. The logic system may be configured to cause data regarding a virtual token assigned to a non-member of a player loyalty program to be deleted after a gaming session.

However, in some implantations, the logic system may cause a virtual token assigned to a non-member of a player loyalty program to persist. For example, the logic system may be configured to cause data regarding a virtual token assigned to a non-member to be written on a portable medium after a gaming session. The logic system may, e.g., control a peripheral device to encode data referencing an awarded virtual token on a machine-readable medium, such as a ticket or a portable storage device. The data may be encoded without reference to an individual player.

Some implementations of the invention provide a gaming method that includes these steps: providing wagering games during a first gaming session; awarding at least one collectible upon the occurrence of an event during the first gaming session; and offering to redeem one or more collectibles in exchange for an opportunity involving wagering game play. A collectible may be associated, for example, with a game theme, a gaming establishment, a gaming machine manufacturer and/or a game provider. In some implementations, the offering step may comprise offering a higher reward for the redemption of multiple collectibles than for individual redemption of the multiple collectibles.

The method may include the step of causing unredeemed collectibles awarded to members of a player loyalty program to persist after the first gaming session. The method may also involve associating the collectible with a player loyalty account and storing data referencing the collectible and the player loyalty account in a storage medium. Depending on the implementation, collectibles awarded to non-members of a player loyalty program may or may not persist after the first gaming session. The method may involve assigning an expiration date to a collectible.

The method may involve encoding data referencing the collectible on a machine-readable medium. The data may be encoded with or without reference to an individual player. The machine-readable medium may, for example, comprise a ticket that is readable by a gaming machine, a kiosk, etc. In some implementations, the ticket may only be redeemable by a participating gaming machine or a participating kiosk.

A collectible may have a single state or multiple states. In some implementations, a player can interact with a collectible to change its state. However, a state change of a collectible may not be completely predictable. For example, a state change in response to a player's interaction may or may not be predictable: in some implementations, a player's interaction may produce either positive or negative results. The collectible may or may not be redeemable for game play.

An event that triggers a collectible award may be a predetermined threshold, e.g., a point threshold of a player tracking program. However, many other types of events that could trigger a collectible award are within the scope of the present invention. For example, the event may be a random event. In some implementations, the event may be defined by a gaming establishment. The event may be a game event, which may or may not be associated with a game outcome. A frequency of awarding collectibles may depend on a player ranking.

The opportunity may require taking a risk. The method may involve determining a player preference and the opportunity may be based on the player preference. The opportunity may, for example, be associated with a game theme, a gaming establishment, a gaming machine manufacturer and/or a game provider. The opportunity may be associated with a location. The opportunity may involve a chance to redeem a collectible for a fixed value or a known prize. The opportunity may comprise a bonus round. The opportunity may comprise a chance to upgrade a paytable. The opportunity may involve a chance to obtain a special game power, such as an advantage in game play. The advantage in game play may or may not be a temporary advantage. The method may involve determining a player rank and the opportunity may be based, at least in part, on the player rank.

The method may also include the steps of determining first through N^{th} probabilities that the collectible will have first through N^{th} corresponding values and assigning the probabilities and the values to the collectible. Alternatively (or additionally), the method may involve determining first through N^{th} times during which that the collectible will have first through N^{th} corresponding values and assigning the times and the values to the collectible.

An alternative gaming method of the invention includes these steps: receiving a data structure comprising image data; extracting the image data; associating the image data with virtual tokens; providing a wagering game; awarding at least one virtual token upon an occurrence of an event during the wagering game; and offering to redeem one or more virtual tokens in exchange for an opportunity involving the wagering game. The image data may be associated with a gaming establishment. The awarding step may involve displaying a virtual token on a display of a gaming machine.

The present invention provides hardware that is configured to perform the methods of the invention, as well as software to control devices to perform these and other methods. For example, methods of this invention may be represented (at least in part) as program instructions and/or data structures, databases, etc. that can be provided on such computer readable media.

Alternative embodiments of the invention provide a gaming network, comprising: a gaming machine configured for providing wagering games during a first gaming session; means for awarding at least one collectible upon the occurrence of an event during the first gaming session; means for offering to redeem one or more collectibles in exchange for an opportunity involving wagering game play; and means for causing unredeemed collectibles awarded to members of a player loyalty program to persist after the first gaming session.

The gaming network may also include means for causing unredeemed collectibles awarded to non-members of a player loyalty program to persist after the first gaming session.

These and other features of the present invention will be presented in more detail in the following detailed description of the invention and the associated figures.

### BRIEF DESCRIPTION OF THE DRAWINGS

FIG. 1 is a flow chart that outlines some methods of the invention.

FIG. 2 is a table indicating a simplified version of a data structure formed according to some methods of the invention.

FIG. 3 is a table indicating a simplified version of a data structure formed according to some methods of the invention.

FIG. 4 is a flow chart that outlines some methods of the invention.

FIGS. 5A and 5B are flow charts that outline some methods of the invention.

FIG. 6 depicts a simplified example of a gaming network that may be used to implement, at least in part, some aspects of the invention.

FIG. 7 is a block diagram of an Arbiter.

FIG. 8 illustrates a gaming machine that may be configured according to some aspects of the invention.

FIG. 9 illustrates a gaming machine and a gaming network that may be configured according to some aspects of the invention.

### DESCRIPTION OF SOME EXAMPLES OF THE INVENTION

In this application, numerous specific details are set forth in order to provide a thorough understanding of the present invention. However, the present invention may be practiced without some or all of these specific details. In other instances, well known process steps have not been described in detail in order not to obscure the present invention.

Some implementations of the invention provide opportunities to earn and/or redeem one or more “collectibles” during the course of playing a wagering game. A collectible (and/or a hierarchy of collectibles) may be associated with a casino. For example, a logo or other image that is associated with a casino may appear on the collectible. In one such example, the collectible could be a coin and the Metro-Goldwyn Mayer (“MGM”) lion could appear on the coin. The collectible may be a representation of the logo, image, etc., that is associated with the casino (e.g., the collectible take the shape of the MGM lion, the lion's head, etc.). The collectible may be associated with a particular type of game (e.g., a heart or a diamond for a playing card game such as video poker) or a game theme (e.g., a Sphinx head or a pyramid for a Cleopatra® game). Alternatively, or additionally, the collectible may be associated with a game producer and/or a gaming machine manufacturer, such as a spade collectible for IGT.

The conditions for obtaining and redeeming collectibles may vary. Preferably, such conditions are configurable, e.g., by a casino.

While in the game (or in a future game), a player may be provided opportunities to obtain and/or redeem one or more collectibles. In some such implementations, a collectible may activate special game features or “powers,” such as a special bonus round, a higher paytable for a defined period of time, the ability to “bump” a reel of a slot game, or other features described in detail herein.

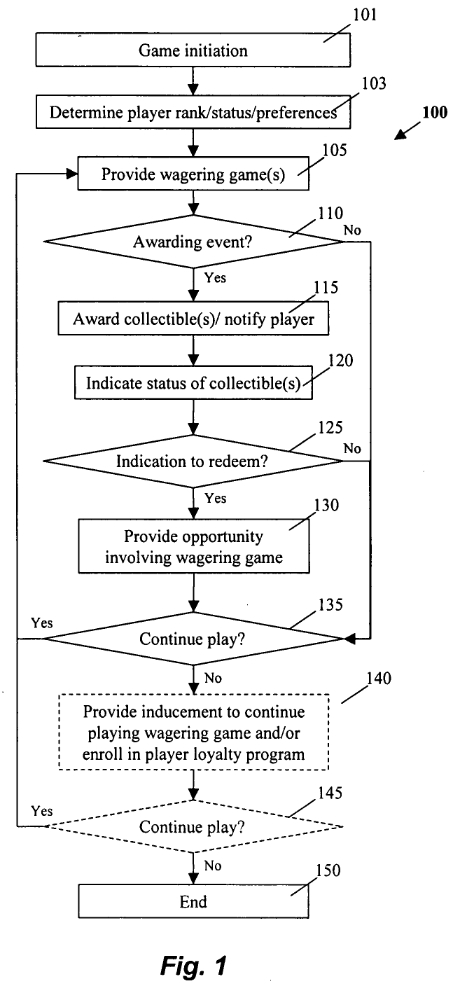

Some implementations of the invention will now be described with reference to FIG. 1 et seq. Steps of the methods shown and described herein may not need to be performed (and in some implementations are not performed) in the order indicated. Some implementations of these methods may include more or fewer steps than those described.

Referring first to FIG. 1, method 100 begins when a gaming machine receives one or more indications that a player wants to initiate a gaming session. (Step 101.) For example, there may be an indication (e.g., a “coin in,” “bill in” or “ticket in” signal) that a player has provided an indicium of credit to a gaming machine. Another such indication may be the detection of a player tracking card or the like by a magnetic card reader, a radio frequency identification (“RFID”) reader, etc. Another indication could be a Wager Account Transfer (“WAT”) from a player's account with a gaming establishment to a game's credit meter.

In step 103, player information is determined. For example, the player's status, rank and/or preferences may be determined. For example, the player may be classified as a new player or a returning player, as being a member or non-member of a player loyalty program, as having or not having previously-awarded collectibles, etc. If a player is a member of a multi-tier player loyalty program, the player's level/rank within that program may be determined. These determinations may have various ramifications, as discussed in more detail below.

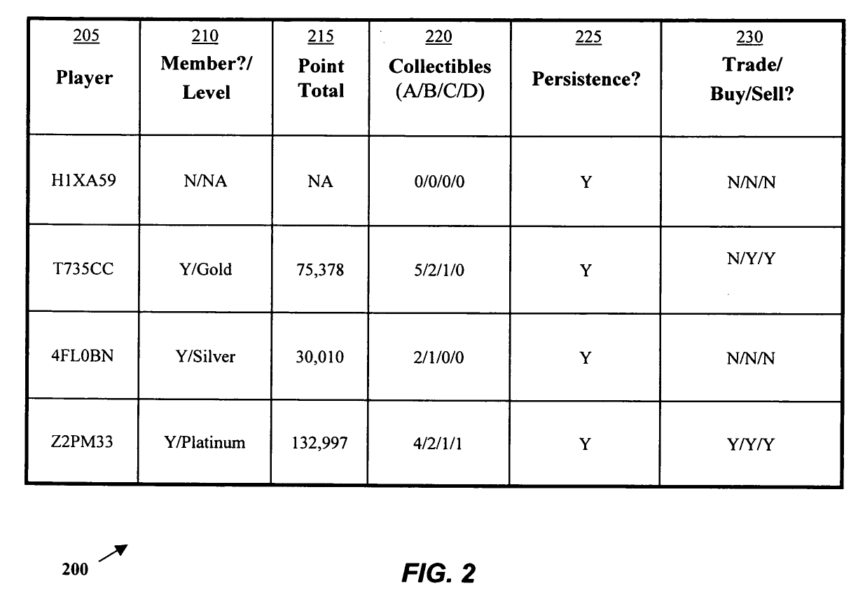

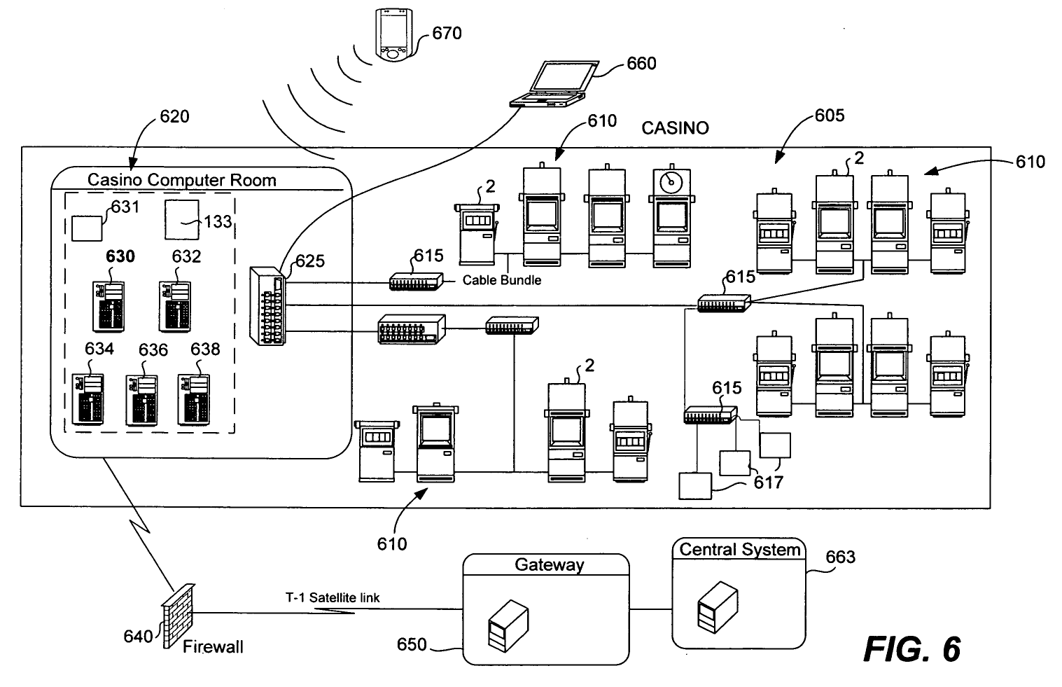

Turning now to FIG. 2, simplified data structure 200 indicates some fields of a database that may be accessed when step 103 is performed. It will be appreciated that the fields selected and the values indicated therein are merely examples chosen to illustrate features of some implementations of the invention. Data structure 200 may be maintained, e.g., in a storage device in, or accessible by, a casino's computer center. For example, data structure 200 may be maintained a storage device of (or accessible by) a server configured to provide player loyalty services. Examples of such devices, networks, etc., will be discussed below with reference to FIGS. 6 through 9.

Player field 205 identifies each player, in this example according to a hexadecimal number. Field 210 indicates whether or not a player is a member of a player loyalty program. Moreover, if a player is a member of the casino's player loyalty program, field 210 indicates the player's level within that program. In this example, the player loyalty program has three different levels. The lowest level is a “silver” level, the intermediate level is a “gold” level and the highest level is a “platinum” level. Here, player 4FL0BN is a member of the player loyalty program at the silver level, player T735CC is a member at the gold level and player Z2PM33 is a member at the platinum level. However, player H1XA59 is not a member of the casino's player loyalty program, so the “level” portion of the field is not applicable.

Field 215 indicates the point totals for members of the player loyalty program. Again, player H1XA59 is not a member of the casino's player loyalty program, so field 215 is not applicable.

Field 220 indicates collectibles that have been awarded to a player and not yet redeemed. Moreover, field 220 indicates what type(s) of collectible the player may have. In this example, there are four types of collectibles; it will be appreciated that any convenient number of collectibles may be used. The types of collectibles may also vary according to the implementation. In this example, types A, B, C and D represent different levels of a 4-level hierarchy of collectibles, wherein collectibles at different levels of the hierarchy have relatively different values. In some such hierarchies, a collectible at one level of the hierarchy may be worth N collectibles at another level of the hierarchy. For example, 5 gold nuggets could be worth 1 golden egg.

There are various advantages of forming generalized hierarchical structures for collectibles. One advantage is the ability to create a general framework that may be adapted for many possible customer preferences as to the appearance, attributes and values of the actual collectibles program implemented by a customer, e.g., by a casino. As discussed in more detail below, customers may be provided with a general framework, e.g., expressed as software for which implementation details are expressed as “blanks” and/or configurable default values. The customers may, for example, be allowed to select from a library of collectible images and/or add customized collectible images to such a framework. The customers may be able to select the number of levels in a collectible hierarchy, choose images and attributes for each level of the hierarchy, etc.

However, in other implementations, the various collectibles may not have a hierarchical relationship with one another. For example, the collectibles may simply have a different appearance or have other different attributes. For example, collectible A may be a golden key that can allow players into special bonus “doors,” whereas collectible B may be a golden egg that can provide special game features. Moreover, the collectibles may be associated with a particular game type, game theme, game provider, etc.

Here, for example, “platinum level” player Z2PM33 has accrued 4 type A collectibles, 2 type B collectibles, 1 type C collectible and 1 type D collectible. In this example, there are no collectibles yet associated with player H1XA59. It may be, for example, that player H1XA59 is a new player that has not been awarded any collectibles during the present gaming session. However, even though player H1XA59 is not a member of the casino's player loyalty program, the collectibles awarded to player H1XA59 can still persist after a gaming session. (See field 225.) Therefore, it is possible that player H1XA59 has been awarded collectibles in the past and has redeemed all of them.

As described elsewhere herein, such persistence may be enabled by encoding collectibles earned by non-members on a portable medium, such as a printed ticket. This feature allows a player to retain collectibles awarded during a gaming session for future gaming sessions while allowing the player to remain anonymous. Accordingly, even non-members who have been awarded collectibles have an incentive to return to the gaming establishment: the seeds of player loyalty will have been sown.

However, in other implementations of the invention, collectibles (e.g., those awarded to non-members) do not persist after a gaming session has ended. Such non-persistence could provide other incentives that are favorable to a casino. One such incentive is the incentive to prolong a gaming session. For example, suppose a player has accumulated 2 collectibles and needs 3 for a special bonus round. The player may be provided with a prompt, e.g., “You only need one more gold coin to enter the special bonus round!” If she knows she will lose the 2 collectibles if she stops playing, she may be willing to keep playing longer than she would have otherwise.

A casino may also leverage non-persisting collectibles to provide an incentive to join a player loyalty program. For various reasons, some players may hesitate to join a player loyalty program. However, a player's desire to retain collectibles awarded during a gaming session may be enough to overcome the player's resistance, if any, to joining such a program. The casino may encourage the player with a prompt, e.g., “If you join our player loyalty program now, you can keep your gold coins in the bank!”

Field 230 indicates whether collectibles may be obtained or redeemed outside the context of a game. In some implementations, a collectible may only be awarded while a player is playing a wagering game and may only be used for the purposes of that wagering game (or another wagering game). In this implementation, however, only non-members (such as player H1XA59) and the lowest-level players (such as player 4FL0BN) are restricted in this fashion. Here, gold-level players have the option of buying or selling collectibles, e.g., from a casino in exchange for money, for game credits, for player loyalty points, etc. In some implementations, gold-level players may purchase collectibles from other gold-level or platinum-level players at the casino, at related properties, etc., via a gaming network or another network. Such purchases may be made according to an online auction, a fixed price schedule, etc.

In this example, platinum-level players also have the option of trading collectibles. In some such implementations, platinum-level players may trade with other players at the casino, at related properties, etc. For example, platinum-level players may exchange several collectibles of a lower value for one of a higher value.

A hierarchy of collectible types can facilitate such trading or purchasing, though a hierarchical relationship is not essential. As mentioned elsewhere herein, collectibles may relate to game types, game themes, individual properties, multiple, properties, multiple games of a game provider (e.g., multiple IGT games), etc. Not all games provide the same types of opportunities. For example, video poker games have different possibilities as compared to slot games, so the use of collectibles in video poker games will often be different from the use of collectibles in slot games.

However, if a casino so desired, various types of collectibles could be “mapped” to one another in a predictable fashion by reference to a collectible hierarchy. For example, one type A collectible for a particular game theme could be traded for one type A collectible for another game theme, another game type, etc.

However, various other methods may be used for determining the price and/or exchange value of a collectible. Some players may desire collectibles for reasons other than intrinsic value. For example, a player may desire collectibles that are unusual, that are associated with a particular location, a particular event, etc.

In some implementations of the invention, collectibles that only a high-level member can earn may not be purchased, traded for or otherwise obtained by lower-level players. However, allowing lower-level players to obtain such collectibles from higher-level players could add to the value of such collectibles, particularly if an auction-type process is used for the transactions: by increasing the size of the potential market and including players who cannot otherwise obtain such collectibles, the overall demand and price may increase. By leveraging the relative scarcity of such high-level collectibles, additional value can be provided to high-level members of a loyalty program at no additional cost to the casino.

Alternative implementations may allow at least some players to share collectibles. For example, a player loyalty account could identify a spouse, one or more friends or family members, etc., who may transfer collectibles between one another. The transfers may be two-way, one-way, or some combination thereof. For example, a player loyalty account may reference persons X, Y and Z. Person X may have the authority to use the collectibles of person Y, but not vice versa. However, persons Y and Z may have the authority to use each other's collectibles. Some such implementations may require the notice and consent of the other player(s) before a collectible is transferred. According to some aspects of the invention, players can create virtual teams that can trade collectibles, be awarded bonus and/or celebration payments within the team, compete in personal team tournaments, etc.

In some implementations, both the awarding and use of collectibles may be shared. For example, consider a player loyalty account that references persons W, X, Y and Z. If player W is awarded a high-level collectible, players X, Y and/or Z may be awarded something, e.g., a lower-level collectible.

Other types of player information may be determined in step 103. (See FIG. 1.) Some such information may involve player preferences. In some implementations of the invention, a player's preferences may include the appearance of a collectible “skin.” For players enrolled in a player loyalty program, these preferences could be determined by reference to data stored for such players, e.g., in a player loyalty database, on a portable memory device, etc. If so desired, preferences of non-members could be determined by prompting players to make a selection. For example, a player could select from “canned” skins and/or select attribute options (e.g., golf equipment, Easter eggs, color scheme).

In preferred implementations of the invention, however, the operator/casino has more flexibility than the player in determining the appearance of collectibles. This allows the casino to “brand” its collectibles while (optionally) providing some flexibility to players regarding personalization of their collectibles. For example, a player may have the option of lower-level personalization, such as choosing a color for the same collectible, e.g., choosing a blue egg instead of a pink egg. Such options may be implemented, e.g., according to a set of files that the casino operator has put together and made available to the players.

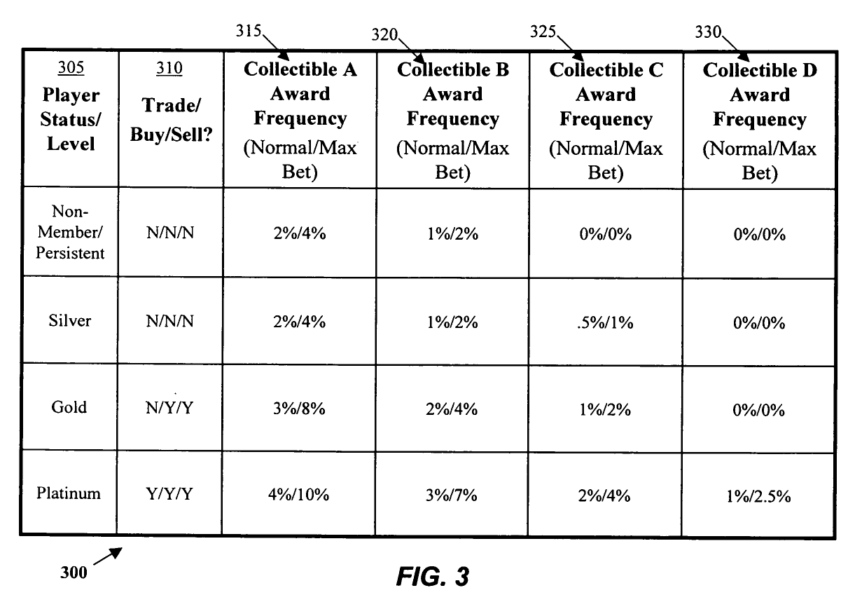

Referring now to FIG. 3, data structure 300 indicates some examples of relationships between levels of a player loyalty program and aspects of a related collectibles program. A comparable data structure may be stored, for example, in a memory of an individual gaming machine. The values indicated in data structure 300 are merely examples expressed in human-readable form. Preferably, the values of the data structure are configurable, e.g., according to commands and/or data provided by a server-based gaming/casino management system such as that described below. A casino may choose to set the collectible award frequency higher or lower than indicated, may alter the award frequency during certain dates or times (e.g., as part of a promotion), etc.

Here, the player levels indicated in field 305 correspond with the three-level player loyalty program described with reference to FIG. 2. As described above, field 305 indicates that non-members will have persistent collectibles. As with other settings and values pertaining to a collectibles program, field 305 could be re-configured to indicate that non-members will not have persistent collectibles.

Changing this setting will affect, for example, whether or not a gaming machine will be configured to record values indicating a player's collectibles on a portable medium. In this example, if a player is identified as a non-member in step 103 (see FIG. 1) and a flag of field 305 is set to “persistent,” a gaming machine will record values indicating a player's collectibles on a ticket at the end of the player's gaming session. Similarly, this setting may affect the kinds of prompts made to a player, as indicated above.

Similarly, the values indicated in field 310 correspond with the trade/buy/sell options of members and non-members of the three-level player loyalty program described with reference to FIG. 2. In some implementations of the invention, a gaming machine may be configured to facilitate the buying, selling and/or trading of collectibles by a player. For example, the gaming machine may communicate with one or more servers configured to provide such features via a gaming network. Here, after the status, level, preferences, etc., of a player have been determined in step 103 (see FIG. 1), the corresponding settings of field 310 will determine whether the buying, selling and/or trading features are enabled or disabled.

Moreover, in this example, the status and level of a player that are determined in step 103 will determine the corresponding collectible award frequencies. Here, collectible A is the lowest-level collectible in a 4-level hierarchy of collectibles. Accordingly, in this implementation, collectible A is relatively easier to obtain. Therefore, for a given player rank, the award frequency values indicated in field 315 are higher than the award frequency values indicated in fields 320, 325 and 330.

For example, a non-member will normally have a 2% probability of obtaining collectible A while playing one instance of a game (e.g., one “hand” in a video poker game). If a non-member is playing “Max Bet,” the non-member will have a 4% probability of obtaining collectible A while playing one instance of a game. However, the non-member's probability of obtaining collectible B while playing one instance of a game is normally 1%, but increases to 2% when the non-member is playing “Max Bet.” In this implementation, non-members are not permitted to obtain higher-level collectibles C or D.

The determination of whether to award a collectible may be made locally, e.g., by a random number generator of an individual gaming machine. Alternatively, this determination may be made by another device, e.g., by a server.

In this example, the award frequencies of collectibles A and B are set to be the same for non-members as for members at the silver level. However, a silver-level member may be awarded higher-level collectible C.

As noted above, however, in preferred implementations collectible-related settings and values are configurable. Therefore, a casino may decide to set the award frequencies of collectibles higher or lower for non-members as compared to some members. For example, a casino may determine that it is more advantageous to set the collectible award frequencies higher for non-members, assuming that non-members would more quickly gain interest in the collectibles program. This could be a strong incentive if, for example, a player is earning collectibles at a relatively high rate and knows that the collectibles are not persistent.

On the other hand, a casino may choose to reward its members by providing them with higher collectible award frequencies. In this example, a platinum-level member's probability of obtaining collectible A while playing one instance of a game is normally 4%, which is twice that for a non-member. Moreover, a platinum-level member's probability of obtaining collectible A increases to 10% when the platinum-level member is playing “Max Bet.” This is 2.5 times the corresponding probability for a non-member. Moreover, a platinum-level member has an opportunity to obtain higher-level collectibles C and D.

In some implementations, the magnitude of a collectible award may be based on a player's rank in a player loyalty program. For example, a gold-level player might be awarded 5 gold coins for the same event that would cause a silver-level player to obtain 3 gold coins.

Returning now to FIG. 1, in step 105 the player is provided with wagering games. In step 110, it is determined (e.g., by the gaming machine) whether an event has occurred that indicates a collectible should be awarded. One such event would be a positive determination of, e.g., a random number generator according to a collectible award frequency.

However, various other events could trigger an award. For example, a casino may determine that a collectible will be awarded upon the occurrence of events associated with a particular gaming session. For example, a collectible may be awarded after a player has wagered (or lost) a predetermined amount of money, when a gaming session has lasted for a predetermined amount of time, etc. A collectible may be awarded to celebrate a significant win by the player or by another player.

Alternatively, or additionally, a collectible may be awarded according to information about the player that may be, e.g., stored in a database of a player loyalty program. For example, a player may be awarded one or more collectibles on the player's birthday, wedding anniversary, etc. (E.g., “Hey, it's your birthday today! Here's a gold coin!”)

A collectible may be awarded upon the occurrence of other events, which may be casino-defined. For example, a collectible could be awarded according to the occurrence of predetermined events of a wagering game, e.g., four-of-a-kind with a specified card, a number of specified symbols on a payline, etc.

Collectibles and/or game credits may be included in a promotional package and provided to players. For example, a player may receive X promotional credits and Y collectibles for use in a particular IGT Game or IGT game theme. Such promotions may be made, e.g., by encoding information on a portable medium such as an Enhanced EZ Pay™ Ticket.

A collectible award may be based on a wager amount. As previously mentioned, a higher wager may correspond with an increased probability of earning a collectible. However, the type of collectible could also vary with wager amount. For example, if a player is playing Max Coin, the player may receive a golden egg instead of a golden coin. In some implementations, collectibles will only be available when a player is wagering at or above a predetermined threshold, has wagered at least a cumulative amount, etc. For example, a particular collectible might only be available when playing Max Coin, when playing it for a certain length of time/number or wagers, etc.

A collectible award may be based on a wager amount in other ways. For example, a wagering threshold that will trigger a collectible award may be predetermined, yet variable. In some such implementations, the predetermined wagering threshold may vary according to player rank.

In other implementations, the predetermined wagering threshold may vary according to other factors, at least some of which may be randomly determined. For example, the predetermined wagering threshold may be randomly selected, e.g., at the beginning of player's gaming session. In some such implementations, the predetermined wagering threshold may be a randomly-selected number that is constrained by a maximum and/or a minimum value. The maximum and/or minimum values are preferably configurable by a gaming establishment.

In one such example, a wagering threshold may be randomly selected out of a range of values from $0 to a maximum value, such as $100. The wagering threshold may apply to a single gaming session or to multiple gaming sessions. For example, when a player initiates a gaming session, a wagering threshold of $63 may be determined by a random number generator (“RNG”) or the like. The RNG may reside in the gaming machine, a server, etc. A collectible will be awarded when the player has wagered $63, i.e., when the “coin in” indicates $63 or more. In some such implementations, the player may be provided encouraging messages (e.g., “countdown” messages or the like) when the player is approaching the threshold.

In some implementations, player ranking/evaluation (see step 103 and related description) may be an ongoing process, even during an individual gaming session. More frequent ranking/evaluation could reward “hot players” who have been playing/betting a lot in the recent past, or have otherwise met certain play criteria in a predetermined time. The reward may be a greater likelihood of obtaining collectibles, the reward of otherwise unobtainable collectibles, etc.

Moreover, in some implementations of the invention, times for earning and redeeming collectibles may be scheduled separately. For example, a casino may determine that collectibles can only be awarded on one or more predetermined days (e.g., only on Monday through Wednesday), and only redeemed on one or more predetermined days (e.g., only on Thursday). There may or may not be an overlap of awarding days and redemption days. In this example, there is no such overlap, because the only redemption day (Thursday) is not a day on which collectibles may be awarded (Monday through Wednesday only). However, in other implementations there is at least one day on which collectibles may be both awarded and redeemed.

Unless and until a collectible is awarded, the wagering game may be provided so long as the player indicates a desire to continue play. (Step 135.) Such a desire may be inferred unless there is a negative indication, e.g., the player hits a “Cash Out” button, removes a player tracking card, reaches a low/zero credit balance, etc.

When a collectible is awarded (step 115), a player should be notified, e.g.:
Congratulations! You just collected a Golden Egg! Use the Golden Egg during the course of the game for [special game feature(s)].

Preferably, the player's collectible status, thresholds for use, etc., should be indicated clearly, in order to provide the player with an incentive for continued play. (Step 120.) The indications may be made via visible and/or audible means, e.g., via a gaming machine's display and related audio. The system preferably indicates to a player how many more collectibles are required to reach the next level, decision point and/or option of using the collectible. In some implementations of the invention, the further the player progresses in a game, the greater the reward and probability of winning a larger award.

For example, if a player needs to have 5 golden nuggets to get into the next special game, the player should be informed how many nuggets the player currently has and how many more the player needs. If the player knows that s/he has 3 nuggets already, the player may not know how long it will take to get the next 2 nuggets, but the player knows that s/he is more than halfway there.

According to one such display, a line indicator moves closer to a top or end portion of a display as a player gets closer to goal. Collectibles may be displayed along the edge of a screen, in a pop-up or other window, and/or in a dedicated area of a display. In some such displays, collectibles already accumulated are lit up and collectibles needed to reach a decision point are dark. In this example, the display could indicate 5 shadows of golden nuggets, of which 3 are lit up and 2 are empty.

In this example, the player continues to play a slot game and receives various collectibles, including 5 golden eggs. Then, during the course of a spin, a bonus round may occur. One of the selections on the bonus round screen may offer an opportunity, e.g.:
For entry into this special bonus kingdom, use 3 Golden Eggs for passage.

Here, the player indicates acceptance of this offer, e.g., by touching an area of a touch screen, pressing a button, etc. (Step 125.) By using 3 of the 5 golden eggs, the player is provided the opportunity of a special round where a higher bonus may potentially be given out. (Step 130.)

This example of collectible redemption falls into a general category wherein a player redeems collectibles in exchange for an opportunity of unknown value. In other examples, a player redeems one or more collectibles in exchange for opportunity of known value, e.g., in exchange for a known number of free spins. In some implementations of the invention, at least some types of collectibles may be redeemed for non-gaming purposes, e.g., for cash, comps, player loyalty points, etc.

The present invention encompasses many permutations of this category (and others). Some such implementations provide a combination of known and unknown redemption types at different decision points. For example, in exchange for the same type of collectible, a player may earn a guaranteed 10 free spins on first level of a wagering game and a guaranteed 15 free spins on a second level of the game. However, on Level 3 the player may have the option of exchanging the same type of collectible for an unknown value between, e.g., 5 and 25 free spins.

In some implementations of the invention, a player may be provided the choice of redeeming one or more collectibles for a relatively lower-value opportunity or accumulating collectibles for a known, higher-value (or a potentially higher-value) opportunity at a later time. The amalgamation of collectibles may result in a higher award than if the collectibles were redeemed separately.

Many characteristics may apply when configuring how and where a collectible may be redeemed. For example, a particular collectible may be awarded and redeemed only when playing a predetermined game theme, e.g., any Cleopatra game. This collectible may be awarded and redeemed only at a single site or at multiple sites and/or enterprises. A collectible may be awarded and redeemed only by a particular game provider. For example, a collectible may only be awarded and/or redeemed when playing an IGT game.

Some collectibles may be themed according to a particular casino and may only be awarded and redeemed at one or more properties of that casino. For example, Harrah's may have a collectible specific to a Las Vegas property and only redeemable there. Harrah's may also have a collectible that can be awarded and redeemed at any Harrah's property.

In some implementations of the invention, higher-level members of a player loyalty program may be provided with advantages when redeeming collectibles. For example, an opportunity may require that a platinum-level member redeem 1 type A collectible, whereas the same opportunity may require that a non-member redeem 2 type A collectibles. Higher-level members of a player loyalty program may be provided with opportunities that are not available to lower-level members or non-members. Some such opportunities may require the redemption of collectibles that only a high-level member can earn, e.g., collectible D of FIG. 3.

Moreover, the redemption process and use of the collectible may differ based upon player preferences. Such preferences may be determined by reference to a player loyalty database, by gathering data during a non-member's gaming session, etc. For example, Player 1 may prefer to earn collectibles for the opportunity of a special bonus round with a potentially high reward, whereas Player 2 may be more interested in the opportunity to have special “powers” during game play, e.g., having a more advantageous paytable for a defined period of time. The paytable may be changed, for example, according to the methods described in U.S. patent application Ser. No. 11/225,407 (Attorney Docket No. IGTIP237/P-1051), by Wolf et al., entitled “METHODS AND DEVICES FOR MANAGING GAMING NETWORKS” and filed Sep. 12, 2005, which is hereby incorporated by reference. Other types of special game powers may involve, e.g., being able to “bump” a reel of a slot game, having an extra Ace or wild card in a poker game, etc.

Such preferences may be accommodated by assigning different redemption values to different collectibles or by assigning different states to the same collectible. For example, collectible A may be redeemed to enter the special bonus round and collectible B may be redeemed for one or more special game powers. Alternatively, the state of a collectible may depend on the player who obtains the collectible. For example, if collectible A is obtained by Player 1, collectible A may be redeemed to enter the special bonus round. However, if collectible A is obtained by Player 2, collectible A may be redeemed for a special game power.

Other “multi-state” collectibles and associated opportunities are provided by the present invention. Some such implementations include an element of uncertainty with respect to redeeming the collectible or otherwise interacting with the collectible. In some multi-state implementations, a player's redemption of (or interaction with) a collectible may have a potential upside and a potential downside.

For example, a player may have the option of interacting with a collectible in an attempt to make it more valuable, but in so doing takes the chance of ruining it, or at least in decreasing its value. In one such example, a player may have acquired, e.g., a “diamond” collectible which the player may optionally attempt to “cut” or “polish” to make it even more valuable, e.g., by making selections from a graphical user interface, operating a game control, etc. If a player succeeds, the diamond may be more valuable and may be redeemed for greater opportunities. However, if the player fails, the diamond could shatter, could be damaged, etc. The result may depend on a player's skill, a player's level of a player loyalty program and/or may be (at least in part) randomly determined. For example, a platinum-level player's attempt may have an 80% change of success, whereas a non-member may only have a 25% chance of success.

In another example, the value of a collectible may be different at different times, which may or may not correspond to events of a wagering game. The player may or may not be informed as to which times are more favorable for redeeming the collectible. There may be different times and/or stages of a game during which there is nothing but a safe outcome when interacting or redeeming a multi-state collectible. However, there could be other stages during which the outcome could potentially be negative.

A player may have the option of using a collectible as it is or “opening it” to see what is inside. The contents of the collectible may differ depending on when the collectible is “opened.” In one such example, a player may have the options of either using a golden egg as it is or opening the golden egg to use what is inside. The golden egg itself may be redeemable for a particular opportunity. At some times, there may be may be a golden key inside the golden egg that can be used in a special part of a wagering game. The golden key may be more valuable than the golden egg, or at least may allow the player a greater opportunity of some kind in the game. In one such example, the player could be presented with a graphic of using the key to open a door when the bonus round begins. At other times, the golden egg may have “fools' gold” or the like inside, making the golden egg worthless.

The wagering game will be provided so long as the player has sufficient credit indicates a desire to continue play. (Step 135.) As mentioned elsewhere, such a desire may be inferred unless there is a negative indication, e.g., the player hits a “Cash Out” button, removes a player tracking card, reaches a low/zero credit balance, etc.

When such a negative indication is received, some implementations of the invention provide a further prompt and/or inducement for the player to continue the wagering game. (Step 140.) In one such example, the player is reminded that a threshold for using collectibles is within reach, e.g.:

An audio and/or video prompt may indicate, e.g.:

Hey, you have 3 golden nuggets! You only need 2 more to enter into the “Diggin' for Gold” bonus round! Continue Play?

In step 140 (or at another time/step), non-members may be encouraged to join a player loyalty program. As mentioned elsewhere herein, such an inducement may be more effective if the player realizes that a non-member's accumulated collectibles will be lost at the end of a gaming session. Particularly if a player has accumulated a number of collectibles during a gaming session, the player may have become enthusiastic about the collectibles program and may want to keep the collectibles. A non-member may be further induced to enroll by the offer of a free collectible, e.g., a free golden egg.

The player may be encouraged to continue playing. If so, the wagering game will continue to be provided. (Step 105.) If the player decides to end the gaming session, the process continues to step 150.

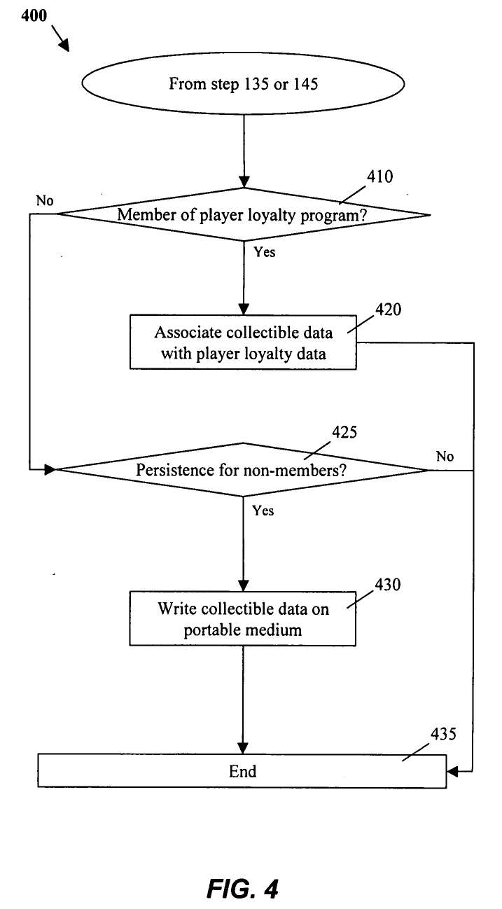

Method 400 of FIG. 4 indicates the steps of a session-ending process according to some implementations of the invention. In this example, method 400 provides additional steps that may follow step 135 or step 145 of method 100. As noted elsewhere, collectibles awarded during a gaming session may or may not persist after the gaming session is completed. According to method 400, collectibles awarded to members of a player loyalty program will persist. Accordingly, if it is determined in step 400 that the player is a member of a player loyalty program (step 410), collectible data will be associated with the member's other player loyalty data and stored, e.g., in a player loyalty database. (Step 420.)

In this example, a non-member's collectibles will also persist. Therefore, if it is determined in step 400 that the player is a member of a player loyalty program (step 410), collectible data are written on a portable medium. (Step 430.) The portable medium may be, for example, a paper ticket. However, in other implementations, the portable medium may be a portable storage device, such as a memory of a USB dongle or the like, a personal digital assistant, a cellular telephone, etc. If any such alternative implementations are provided, it is preferable to require a process of authenticating the portable memory device, e.g., via a digital signature, before accepting the collectibles for future gaming sessions or other uses.

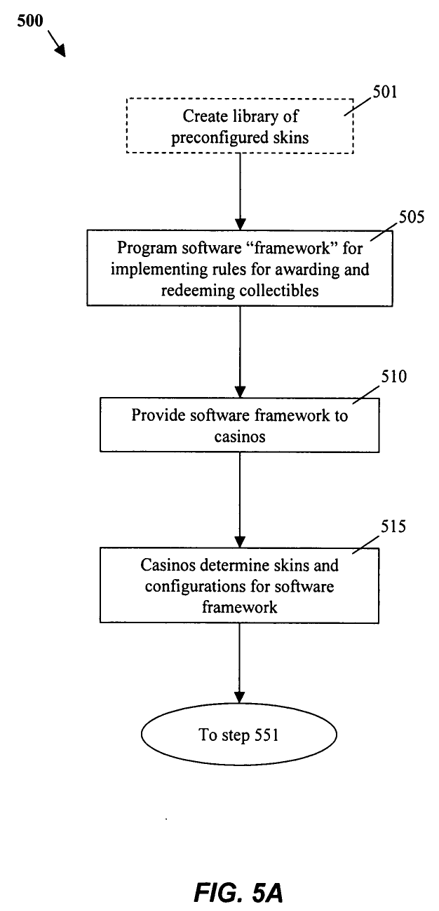

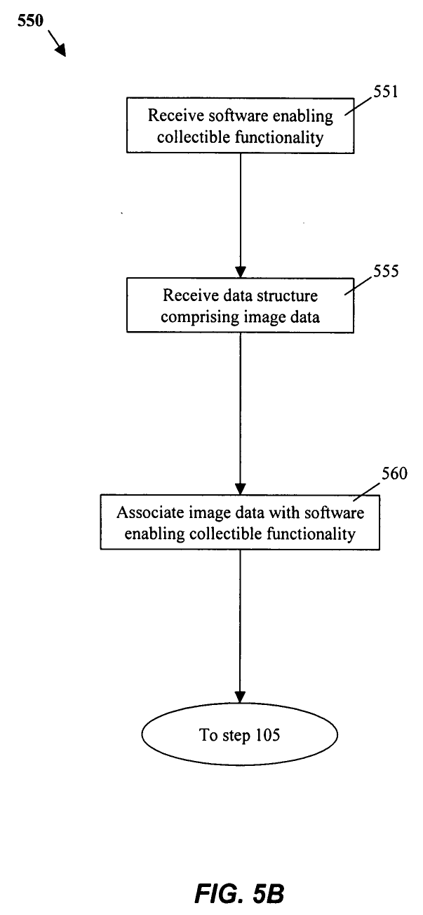

Some methods of allowing casinos to customize their own collectibles programs will now be described with reference to FIGS. 5A and 5B. Referring first to FIG. 5A, method 500 may involve providing a number of preconfigured “skins” or images for use by the casino. (Step 501.) Such skins may graphics files that can define, at least in part, the appearance of a collectible. For example, various skins may be provided for creating collectibles relating to sporting events (e.g., the Super Bowl, NASCAR, etc.) holidays (e.g., Chinese New Year, Halloween), seasons, etc. A basic collectibles package may include a set of defined collectibles such as golden eggs, golden keys, golden nuggets, lucky clovers, etc.

However, casinos are constantly making efforts to brand themselves. Accordingly, some aspects of the invention provide casinos an option of making customized collectibles that are theme-oriented and/or property-oriented. Whether the property is Caesar's Palace, Bellagio, Luxor, etc., there are associated images that may be made into game collectibles. Caesar's Palace may wish to use images of the Colosseum, Caesar's head, a Roman figure in a toga, etc. The MGM/Mirage might have a New York, N.Y. theme having collectibles referencing the Statue of Liberty, the Empire State Building, hubcaps, etc.

In step 505, one or more templates, also referred to herein as “frameworks,” are developed for implementing a collectibles program. The framework(s) may, e.g., comprise software for which implementation details are expressed as “blanks” and/or configurable default values. The customers may be allowed to select from a library of collectible images and/or add customized collectible images to such a framework. The customers may be able to select the number of levels in a collectible hierarchy, choose images and attributes for each level of the hierarchy, etc. The framework may have configurable values regarding the acquisition, redemption, persistence, etc., of collectibles for various levels of a player loyalty program.

In some implementations of the invention, the software framework may be part of a software developer's kit that would allow a customer, (e.g., a casino) to produce a hierarchy of tokens and a library of possible tokens. The kit may include a software framework, rules and possibly a graphical user interface (such as a “wizard”) for applying the rules to the software framework. In order to display a collectible, the framework may be configured to access graphics files within a certain size range (e.g., no more than X by Y pixels) and with one or more specific formats. The graphics files may be from a library of collectible skins or may be new graphics files provided by a customer, if the file type and size of the new graphics files is conformable.

The kit may include other features, such as paytables, etc., that correspond with features of a collectible. In some implementations of the invention, server-based game features will include the ability to use defined collectibles during the course of certain game types and/or game themes. Some aspects of awarding and redeeming collectibles may be preconfigured and others may be configurable.

In step 510, the framework is provided to casinos. The casinos may use the framework to implement a customized collectibles program. For example, an operator may select the number of levels in a collectibles hierarchy, determine configurations for each level, selecting and/or creating new skins for the collectibles, assigning values associated with levels of a player loyalty program, etc. (Step 515.)

Depending on the implementation, a software framework may be associated with specific collectible skins, etc., in different ways and by different devices. For example, this association may take place at the server level for casino-wide collectible themes. However, this association may take place at the server level or the gaming machine level for collectibles pertaining to a game theme.

Referring now to FIG. 5B, in step 551 a machine receives software enabling collectible functionality. For example, the machine may be a gaming machine. The software may include instructions for awarding and redeeming collectibles that pertain to the game theme(s) currently installed on the gaming machine. However, the collectibles may pertain to the game theme(s), to the game type, to the casino in which the gaming machine is located and/or to the manufacturer of the gaming machine. The software may be received by downloading, e.g., according to a server-based gaming network as described elsewhere herein.

In step 555, the machine receives a data structure that includes image data for displaying collectibles. The game themes may, for example, have blank icons that are part of the game code. In step 560, the downloaded images are associated with the software that enables collectible functionality, e.g., by taking the place of the blank icons. By using format rules, one can ensure that the downloaded images are the right size and file type. The games are initialized with the rules and images, so that these graphics can be interjected as collectibles within the game. The process may continue, for example, to step 105 of FIG. 1.

Information relevant to managing gaming networks, data communication within gaming networks, etc., is set forth in U.S. patent application Ser. No. 11/225,407 (Attorney Docket No. IGT1P237/P-1051), by Wolf et al., entitled “METHODS AND DEVICES FOR MANAGING GAMING NETWORKS” and filed Sep. 12, 2005, in U.S. patent application Ser. No. 10/757,609 by Nelson et al., entitled “METHODS AND APPARATUS FOR GAMING DATA DOWNLOADING” (Attorney Docket No. IGT1P213/P-657) and filed on Jan. 14, 2004, in U.S. patent application Ser. No. 10/938,293 by Benbrahim et al., entitled “METHODS AND APPARATUS FOR DATA COMMUNICATION IN A GAMING SYSTEM” (Attorney Docket No. IGT1P199/P-909) and filed on Sep. 10, 2004, in U.S. patent application Ser. No. 11/225,337 (Attorney Docket No. IGT1P185/P-1017) by Nguyen et al., filed Sep. 12, 2005 and entitled “DISTRIBUTED GAME SERVICES” and in U.S. patent application Ser. No. 11/173,442 (Attorney Docket No. IGT1P153/P-991) by Kinsley et al., filed Jul. 1, 2005 and entitled “METHODS AND DEVICES FOR DOWNLOADING GAMES OF CHANCE,” all of which are hereby incorporated by reference in their entirety and for all purposes. Some examples of gaming networks and devices are set forth below.

One example of a network topology for implementing some aspects of the present invention is shown in FIG. 6. Those of skill in the art will realize that this exemplary architecture and the related functionality are merely examples and that the present invention encompasses many other such embodiments and methods. Here, for example, a single gaming establishment 605 is illustrated, which is a casino in this example. However, it should be understood that some implementations of the present invention involve multiple gaming establishments.

Gaming establishment 605 includes 16 gaming machines 2, each of which is part of a bank 610 of gaming machines 2. In this example, gaming establishment 605 also includes a bank of networked gaming tables 617. It will be appreciated that many gaming establishments include hundreds or even thousands of gaming machines 2 and/or gaming tables 617, not all of which are included in a bank. However, the present invention may be implemented in gaming establishments having any number of gaming machines, gaming tables, etc.

Various alternative network topologies can be used to implement different aspects of the invention and/or to accommodate varying numbers of networked devices. For example, gaming establishments with very large numbers of gaming machines 2 may require multiple instances of some network devices (e.g., of main network device 625, which combines switching and routing functionality in this example) and/or the inclusion of other network devices not shown in FIG. 6. For example, some implementations of the invention include one or more middleware servers disposed between gaming machines 2 and server 630. Such middleware servers can provide various useful functions, including but not limited to the filtering and/or aggregation of data received from bank switches 615, from individual gaming machines and from other player terminals. Some implementations of the invention include load balancing methods and devices for managing network traffic.

Each bank 610 has a corresponding bank switch 615, which may be a conventional bank switch. Each bank switch is connected to server-based gaming (“SBG”) server 630 via main network device 625, which combines switching and routing functionality in this example. Although various floor communication protocols may be used, some preferred implementations use IGT's open, Ethernet-based SuperSAS® protocol, which IGT makes available for downloading without charge. However, other protocols such as Best of Breed (“BOB”) may be used to implement various aspects of SBG. IGT has also developed a gaming-industry-specific transport layer called CASH that rides on top of TCP/IP and offers additional functionality and security.

SBG server 630, License Manager 631, Arbiter 133, servers 632, 634, 636 and 638, and main network device 625 are disposed within computer room 620 of gaming establishment 605. In practice, more or fewer servers may be used. Some of these servers may be configured to perform tasks relating to player loyalty and/or player tracking, bonusing/progressives, etc. Some servers may be configured to perform tasks specific to the present invention. License Manager 631 may also be implemented, at least in part, via a server or a similar device. Some exemplary operations of License Manager 631 are described in detail in U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., which is hereby incorporated by reference.

SBG server 630 can also be configured to implement, at least in part, various aspects of the present invention. Some preferred embodiments of SBG server 630 and the other servers shown in FIG. 6 include (or are at least in communication with) clustered CPUs, redundant storage devices, including backup storage devices, switches, etc. Such storage devices may include a redundant array of inexpensive disks (“RAID”), back-up hard drives and/or tape drives, etc. Preferably, a Radius and a DHCP server are also configured for communication with the gaming network. Some implementations of the invention provide one or more of these servers in the form of blade servers.

In some implementations of the invention, many of these devices (including but not limited to License Manager 631, servers 632, 634, 636 and 638, and main network device 625) are mounted in a single rack with SBG server 630. Accordingly, many or all such devices will sometimes be referenced in the aggregate as an “SBG server.” However, in alternative implementations, one or more of these devices is in communication with SBG server 630 and/or other devices of the network but located elsewhere. For example, some of the devices could be mounted in separate racks within computer room 620 or located elsewhere on the network. For example, it can be advantageous to store large volumes of data elsewhere via a storage area network (“SAN”).

In some embodiments, these components are SBG server 630 preferably has an uninterruptible power supply (“UPS”). The UPS may be, for example, a rack-mounted UPS module.

Computer room 620 may include one or more operator consoles or other host devices that are configured for communication with SBG server 630. Such host devices may be provided with software, hardware and/or firmware for implementing various aspects of the invention; many of these aspects involve controlling SBG server 630. However, such host devices need not be located within computer room 620. Wired host device 660 (which is a laptop computer in this example) and wireless host device (which is a PDA in this example) may be located elsewhere in gaming establishment 605 or at a remote location.

Arbiter 133 may be implemented, for example, via software that is running on a server or another networked device. Arbiter 133 serves as an intermediary between different devices on the network. Some implementations of Arbiter 133 are described in U.S. patent application Ser. No. 10/948,387, entitled “METHODS AND APPARATUS FOR NEGOTIATING COMMUNICATIONS WITHIN A GAMING NETWORK” and filed Sep. 23, 2004 (the “Arbiter Application”), which is incorporated herein by reference and for all purposes. In some preferred implementations, Arbiter 133 is a repository for the configuration information required for communication between devices on the gaming network (and, in some implementations, devices outside the gaming network). Although Arbiter 133 can be implemented in various ways, one exemplary implementation is discussed in the following paragraphs.

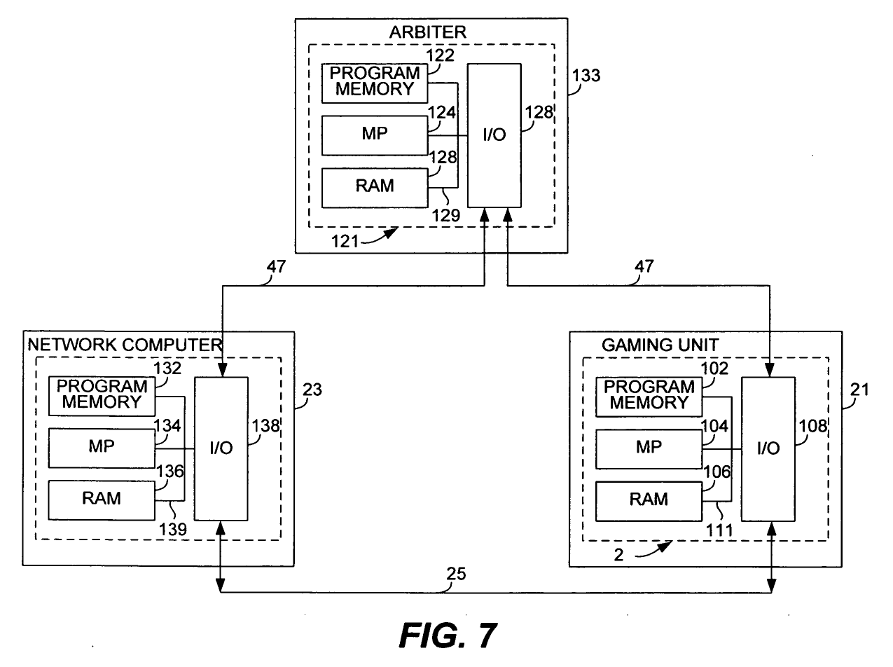

FIG. 7 is a block diagram of a simplified communication topology between a gaming unit 21, the network computer 23 and the Arbiter 133. Although only one gaming unit 21, one network computer 23 and one Arbiter 133 are shown in FIG. 7, it should be understood that the following examples may be applicable to different types of network gaming devices within the gaming network 12 beyond the gaming unit 21 and the network computer 23, and may include different numbers of network computers, gaming security arbiters and gaming units. For example, a single Arbiter 133 may be used for secure communications among a plurality of network computers 23 and tens, hundreds or thousands of gaming units 21. Likewise, multiple gaming security arbiters 46 may be utilized for improved performance and other scalability factors.

Referring to FIG. 7, the Arbiter 133 may include an arbiter controller 121 that may comprise a program memory 122, a microcontroller or microprocessor (MP) 124, a random-access memory (RAM) 126 and an input/output (I/O) circuit 128, all of which may be interconnected via an address/data bus 129. The network computer 23 may also include a controller 131 that may comprise a program memory 132, a microcontroller or microprocessor (MP) 134, a random-access memory (RAM) 136 and an input/output (I/O) circuit 138, all of which may be interconnected via an address/data bus 139. It should be appreciated that although the Arbiter 133 and the network computer 23 are each shown with only one microprocessor 124, 134, the controllers 121, 131 may each include multiple microprocessors 124, 134. Similarly, the memory of the controllers 121, 131 may include multiple RAMs 126, 136 and multiple program memories 122, 132. Although the I/O circuits 128, 138 are each shown as a single block, it should be appreciated that the I/O circuits 128, 138 may include a number of different types of I/O circuits. The RAMs 124, 134 and program memories 122, 132 may be implemented as semiconductor memories, magnetically readable memories, and/or optically readable memories, for example.

Although the program memories 122, 132 are shown in FIG. 7 as read-only memories (ROM) 122, 132, the program memories of the controllers 121, 131 may be a read/write or alterable memory, such as a hard disk. In the event a hard disk is used as a program memory, the address/data buses 129, 139 shown schematically in FIG. 7 may each comprise multiple address/data buses, which may be of different types, and there may be an I/O circuit disposed between the address/data buses.

As shown in FIG. 7, the gaming unit 21 may be operatively coupled to the network computer 23 via the data link 25. The gaming unit 21 may also be operatively coupled to the Arbiter 133 via the data link 47, and the network computer 23 may likewise be operatively coupled to the Arbiter 133 via the data link 47. Communications between the gaming unit 21 and the network computer 23 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), game download information (e.g., game software and game licensing information) and personal information (e.g., social security number, personal preferences, etc.) may be encrypted with stronger encryption techniques such as DES or 3DES to provide increased security.

As disclosed in further detail in the Arbiter Application, the Arbiter 133 may verify the authenticity of each network gaming device. The Arbiter 133 may receive a request for a communication session from a network device. For ease of explanation, the requesting network device may be referred to as the client, and the requested network device may be referred to as the host. The client may be any device on the network 12 and the request may be for a communication session with any other network device. The client may specify the host, or the gaming security arbiter may select the host based on the request and based on information about the client and potential hosts. The Arbiter 133 may provide encryption keys (session keys) for the communication session to the client via the secure communication channel. Either the host and/or the session key may be provided in response to the request, or may have been previously provided. The client may contact the host to initiate the communication session. The host may then contact the Arbiter 133 to determine the authenticity of the client. The Arbiter 133 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 133 may contact the host regarding the request and provide corresponding session keys to both the client and the host. The Arbiter 133 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

Wireless devices are particularly useful for managing a gaming network. Such wireless devices could include, but are not limited to, laptops, PDAs or even cellular telephones. Referring once again to FIG. 6, one or more network devices in gaming establishment 605 can be configured as wireless access points. For example, a casino manager may use a wireless handheld device to revise and/or schedule gaming machine configurations while roaming the casino floor. Similarly, a representative of a regulatory body could use a PDA to verify gaming machine configurations, generate reports, view activity logs, etc., while on the casino floor.

If a host device is located in a remote location, security methods and devices (such as firewalls, authentication and/or encryption) should be deployed in order to prevent the unauthorized access of the gaming network. Similarly, any other connection between gaming network 605 and the outside world should only be made with trusted devices via a secure link, e.g., via a virtual private network (“VPN”) tunnel. For example, the illustrated connection between SBG 630, gateway 650 and central system 663 (here, IGT.com) that may be used for game downloads, etc., is advantageously made via a VPN tunnel.

An Internet-based VPN uses the open, distributed infrastructure of the Internet to transmit data between sites. A VPN may emulate a private IP network over public or shared infrastructures. A VPN that supports only IP traffic is called an IP-VPN. VPNs provide advantages to both the service provider and its customers. For its customers, a VPN can extend the IP capabilities of a corporate site to remote offices and/or users with intranet, extranet, and dial-up services. This connectivity may be achieved at a lower cost to the gaming entity with savings in capital equipment, operations, and services. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes.

There are many ways in which IP VPN services may be implemented, such as, for example, Virtual Leased Lines, Virtual Private Routed Networks, Virtual Private Dial Networks, Virtual Private LAN Segments, etc. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (http://www.vpnc.com, VPNC, Santa Cruz, Calif.).

For security purposes, any information transmitted to or from a gaming establishment over a public network may be encrypted. In one implementation, the information may be symmetrically encrypted using a symmetric encryption key, where the symmetric encryption key is asymmetrically encrypted using a private key. The public key may be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

As mentioned elsewhere herein, U.S. patent application Ser. No. 11/225,408 (Attorney Docket No. IGT1P253), entitled “METHODS AND DEVICES FOR AUTHENTICATION AND LICENSING IN A GAMING NETWORK” by Kinsley et al., describes novel methods and devices for authentication, game downloading and game license management. This application has been incorporated herein by reference.

Providing a secure connection between the local devices of the SBG system and IGT's central system allows for the deployment of many advantageous features. For example, a customer (e.g., an employee of a gaming establishment) can log onto an account of central system 663 (in this example, IGT.com) to obtain the account information such as the customer's current and prior account status.

Moreover, such a secure connection may be used by the central system 663 to collect information regarding a customer's system. Such information includes, but is not limited to, error logs for use in diagnostics and troubleshooting. Some implementations of the invention allow a central system to collect other types of information, e.g., information about the usage of certain types of gaming software, revenue information regarding certain types of games and/or gaming machines, etc. Such information includes, but is not limited to, information regarding the revenue attributable to particular games at specific times of day, days of the week, etc. Such information may be obtained, at least in part, by reference to an accounting system of the gaming network(s), as described in U.S. patent application Ser. No. 11/225,407 (Attorney Docket No. IGT1P237/P-1051), by Wolf et al., entitled “METHODS AND DEVICES FOR MANAGING GAMING NETWORKS,” which has been incorporated herein by reference.

Automatic updates of a customer's SBG server may also be enabled. For example, central system 663 may notify a local SBG server regarding new products and/or product updates. For example, central system 663 may notify a local SBG server regarding updates of new gaming software, gaming software updates, peripheral updates, the status of current gaming software licenses, etc. In some implementations of the invention, central system 663 may notify a local SBG server (or another device associated with a gaming establishment) that an additional theme-specific data set and/or updates for a previously-downloaded global payout set are available. Alternatively, such updates could be automatically provided to the local SBG server and downloaded to networked gaming machines.

After the local SBG server receives this information, it can identify relevant products of interest. For example, the local SBG server may identify gaming software that is currently in use (or at least licensed) by the relevant gaming entity and send a notification to one or more host devices, e.g., via email. If an update or a new software product is desired, it can be downloaded from the central system. Some relevant downloading methods are described elsewhere herein and in applications that have been incorporated herein by reference, e.g., in U.S. patent application Ser. No. 11/078,966. Similarly, a customer may choose to renew a gaming software license via a secure connection with central system 663 in response to such a notification.

Secure communication links allow notifications to be sent securely from a local SBG server to host devices outside of a gaming establishment. For example, a local SBG server can be configured to transmit automatically generated email reports, text messages, etc., based on predetermined events that will sometimes be referred to herein as “triggers.” Such triggers can include, but are not limited to, the condition of a gaming machine door being open, cash box full, machine not responding, verification failure, etc.

In addition, providing secure connections between different gaming establishments can enable alternative implementations of the invention. For example, a number of gaming establishments, each with a relatively small number of gaming machines, may be owned and/or controlled by the same entity. In such situations, having secure communications between gaming establishments makes it possible for a gaming entity to use a single SBG server as an interface between central system 663 and the gaming establishments.

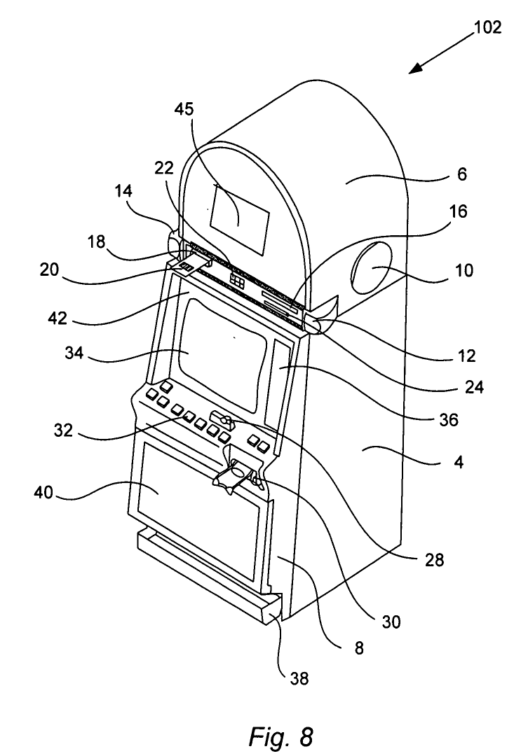

Turning next to FIG. 8, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIGS. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in IGT gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as IGT gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 8, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

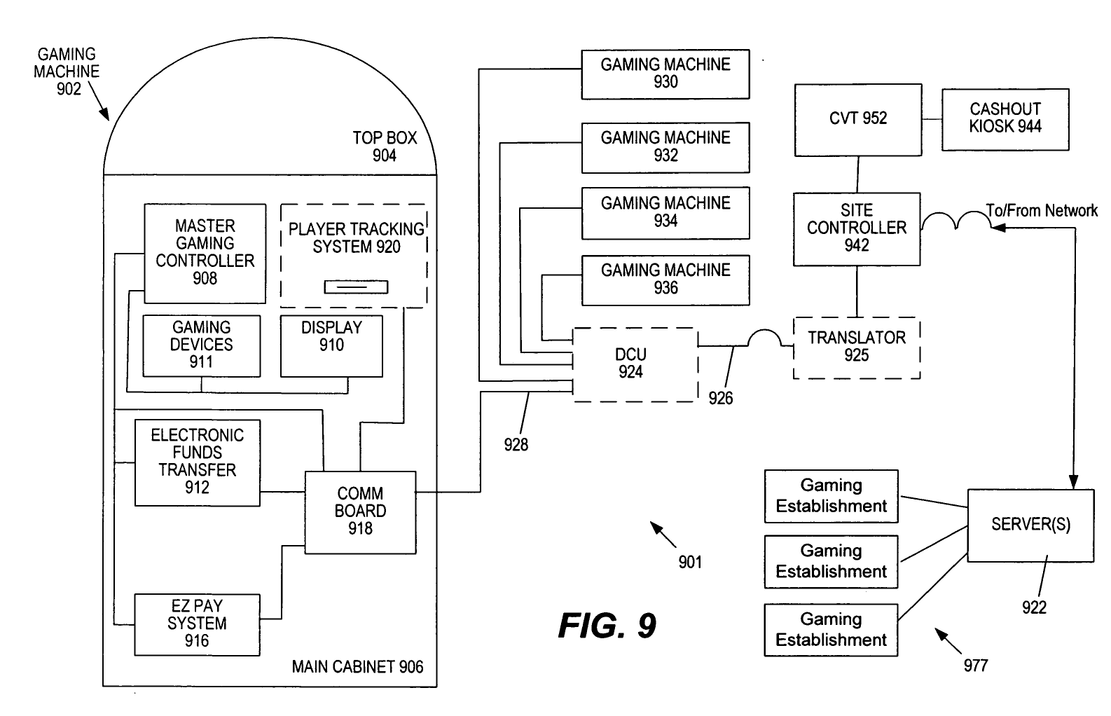

A gaming network that may be used to implement additional methods performed in accordance with embodiments of the invention is depicted in FIG. 9. Gaming establishment 901 could be any sort of gaming establishment, such as a casino, a card room, an airport, a store, etc. In this example, gaming network 977 includes more than one gaming establishment, all of which are networked to game server 922.

Here, gaming machine 902, and the other gaming machines 930, 932, 934, and 936, include a main cabinet 906 and a top box 904. The main cabinet 906 houses the main gaming elements and can also house peripheral systems, such as those that utilize dedicated gaming networks. The top box 904 may also be used to house these peripheral systems.

The master gaming controller 908 controls the game play on the gaming machine 902 according to instructions and/or game data from game server 922 or stored within gaming machine 902 and receives or sends data to various input/output devices 911 on the gaming machine 902. In one embodiment, master gaming controller 908 includes processor(s) and other apparatus of the gaming machines described elsewhere herein. The master gaming controller 908 may also communicate with a display 910.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 908 may also communicate with EFT system 912, EZPay™ system 916 (a proprietary cashless ticketing system of the present assignee), and player tracking system 920. The systems of the gaming machine 902 communicate the data onto the network 922 via a communication board 918.

It will be appreciated by those of skill in the art that embodiments of the present invention could be implemented on a network with more or fewer elements than are depicted in FIG. 9. For example, player tracking system 920 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Moreover, player tracking information may be combined with other information that is now readily obtainable by an SBG system.

Moreover, DCU 924 and translator 925 are not required for all gaming establishments 901. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, in the gaming industry, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machine are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 942 provides this function for gaming establishment 901. Site controller 942 is connected to a central system and/or other gaming establishments via one or more networks, which may be public or private networks. Among other things, site controller 942 communicates with game server 922 to obtain game data, such as ball drop data, bingo card data, etc.

In the present illustration, gaming machines 902, 930, 932, 934 and 936 are connected to a dedicated gaming network 922. In general, the DCU 924 functions as an intermediary between the different gaming machines on the network 922 and the site controller 942. In general, the DCU 924 receives data transmitted from the gaming machines and sends the data to the site controller 942 over a transmission path 926. In some instances, when the hardware interface used by the gaming machine is not compatible with site controller 942, a translator 925 may be used to convert serial data from the DCU 924 to a format accepted by site controller 942. The translator may provide this conversion service to a plurality of DCUs.

Further, in some dedicated gaming networks, the DCU 924 can receive data transmitted from site controller 942 for communication to the gaming machines on the gaming network. The received data may be, for example, communicated synchronously to the gaming machines on the gaming network.

Here, CVT 952 provides cashless and cashout gaming services to the gaming machines in gaming establishment 901. Broadly speaking, CVT 952 authorizes and validates cashless gaming machine instruments (also referred to herein as “tickets” or “vouchers”), including but not limited to tickets for causing a gaming machine to display a game result and cash-out tickets. Moreover, CVT 952 authorizes the exchange of a cashout ticket for cash. These processes will be described in detail below. In one example, when a player attempts to redeem a cash-out ticket for cash at cashout kiosk 944, cash out kiosk 944 reads validation data from the cashout ticket and transmits the validation data to CVT 952 for validation. The tickets may be printed by gaming machines, by cashout kiosk 944, by a stand-alone printer, by CVT 952, etc. Some gaming establishments will not have a cashout kiosk 944. Instead, a cashout ticket could be redeemed for cash by a cashier (e.g. of a convenience store), by a gaming machine or by a specially configured CVT.

Some methods of the invention combine information that can be obtained from game network accounting systems with features described above. By combining, for example, information regarding scheduled gaming machine configurations and information regarding the amount of money that a gaming machine brings in while a gaming machine has a particular configuration, gaming machine configurations may be optimized to maximize revenue. Some such methods involve determining a first rate of revenue obtained by a gaming machine in the gaming network during a first time when the gaming machine has a first configuration. The gaming machine is later automatically configured according to second configuration information supplied by the SBG server, e.g., as scheduled by the Scheduler. A second rate of revenue, obtained by the gaming machine during a second time when the gaming machine has the second configuration, is determined, and so on.

After scheduling various configurations at various times, optimum configurations for the gaming machine may be determined for various times of day. The SBG system can them provide scheduled optimal configurations for the gaming machine at the corresponding times of day. Some implementations provide for groups (e.g., banks) of gaming machines to be automatically configured according to a predetermined schedule of optimal configurations for various times of day, days of the week, times of the year, etc.

In some such implementations, an average revenue may be computed, based on revenue from many gaming machines having the same configuration at the same time of day. These average revenues could be used to determine an overall optimal value for relevant time periods.

Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations would become clear to those of ordinary skill in the art after perusal of this application.

For example, alternative implementations of the invention provide a graphical user interface (e.g., on a gaming machine or a kiosk) that indicates a casino floor. A player may find a game theme they wish to play on the casino floor. Poker games may be located in the Poker Room. Themes such as Creature from the Black Lagoon® may be shown on a theatre marquee.

Other implementations of the invention provide a “scavenger hunt” or the like. In some such implementations, a player needs to earn collectibles on different games within a defined time period. Each player may be required to register and may receive a list that is specific to him or her. As the collectibles are earned on the list (which may, e.g., be viewable on a screen), the player may find another game theme with the next type of collectible or download the game theme at the gaming machine where they are playing.

Still other implementations of the invention involve integration with other systems tracking player spend. The other systems may be, for example, other spending options with a casino (e.g., show tickets, restaurant, retail) or elsewhere. A mechanism may be provided to map restaurant, food and/or beverage purchases to game collectibles. For example, spending $200 for dinner, $500 on show tickets, etc., could provide a customer enough collectibles to enter into a bonus pool. (The conversion rate could be variable, by casino configuration.) This could motivate “professional eaters,” people who come to Vegas to see shows, etc., to start gaming and possibly to obtain a player tracking card.

Accordingly, the present embodiments are to be considered as illustrative and not restrictive, and the invention is not to be limited to the details given herein, but may be modified within the scope and equivalents of the appended claims.

We claim:

1. A gaming machine, comprising:
one or more peripheral devices;
an interface configured for receiving a data structure comprising image data; and
a logic system configured to perform the following tasks:
extract the image data;
associate the image data with virtual tokens; and
control one or more peripheral devices to perform the following tasks:
provide a wagering game;
award one or more virtual tokens upon an occurrence of an event during the wagering game; and
offer to redeem one or more virtual tokens in exchange for an opportunity involving the wagering game.

2. The gaming machine of claim 1, wherein the image data are associated with a gaming establishment.

3. The gaming machine of claim 1, wherein the logic system causes the virtual token to persist after a gaming session.

4. The gaming machine of claim 1, wherein the logic system is configured to determine whether a player is a member of a player loyalty program.

5. The gaming machine of claim 1, wherein the logic system comprises at least one processor.

6. The gaming machine of claim 1, wherein the logic system is further configured to control a peripheral device to encode data referencing an awarded virtual token on a machine-readable medium.

7. The gaming machine of claim 1, further comprising a player tracking device configured for associating the virtual token with a player loyalty account.

8. The gaming machine of claim 4, wherein the logic system is configured to cause a virtual token assigned to a member of a player loyalty program to persist after a gaming session.

9. The gaming machine of claim 4, wherein the logic system is configured to cause data regarding a virtual token assigned to a non-member of a player loyalty program to be written on a portable medium after a gaming session.

10. The gaming machine of claim 4, wherein the logic system is configured to cause data regarding a virtual token assigned to a non-member of a player loyalty program to be deleted after a gaming session.

11. The gaming machine of claim 6, wherein the machine-readable medium comprises a ticket.

12. The gaming machine of claim 6, wherein the machine-readable medium comprises a portable storage device.

13. The gaming machine of claim 6, wherein data are encoded without reference to an individual player.

14. A gaming method, comprising:
providing wagering games during a first gaming session;
awarding at least one collectible upon the occurrence of an event during the first gaming session;
offering to redeem one or more collectibles in exchange for an opportunity involving wagering game play; and
causing unredeemed collectibles awarded to members of a player loyalty program to persist after the first gaming session.

15. The method of claim 14, further comprising the step of causing collectibles awarded to non-members of a player loyalty program to persist after the first gaming session.

16. The method of claim 14, further comprising the step of causing collectibles awarded to non-members of a player loyalty program to be discarded after the first gaming session.

17. The method of claim 14, further comprising:
associating the collectible with a player loyalty account; and
storing data referencing the collectible and the player loyalty account in a storage medium.

18. The method of claim 14, further comprising the step of encoding data referencing the collectible on a machine-readable medium without reference to an individual player.

19. The method of claim 14, wherein the offering step comprises offering a higher reward for the redemption of multiple collectibles than for individual redemption of the multiple collectibles.

20. The method of claim 14, wherein the collectible has multiple states.

21. The method of claim 14, wherein the collectible is redeemable for game play.

22. The method of claim 14, wherein the event is a predetermined threshold.

23. The method of claim 14, wherein the event is a random event.

24. The method of claim 14, wherein the event is defined by a gaming establishment.

25. The method of claim 14, wherein the event comprises a game event.

26. The method of claim 14, wherein the event comprises a game outcome.

27. The method of claim 14, wherein a frequency of awarding collectibles depends on a player ranking.

28. The method of claim 14, further comprising the step of assigning an expiration date to a collectible.

29. The method of claim 14, wherein a collectible is associated with a game theme, a gaming establishment, a gaming machine manufacturer or a game provider.

30. The method of claim 14, wherein the opportunity requires taking a risk.

31. The method of claim 14, further comprising the step of determining a player preference, wherein the opportunity is based on the player preference.

32. The method of claim 14, wherein the opportunity is associated with a game theme, a gaming establishment, a gaming machine manufacturer or a game provider.

33. The method of claim 14, wherein the opportunity is associated with a location.

34. The method of claim 14, wherein the opportunity comprises a chance to redeem a collectible for a fixed value or a known prize.

35. The method of claim 14, wherein the opportunity comprises a bonus round.

36. The method of claim 14, wherein the opportunity comprises a chance to upgrade a paytable.

37. The method of claim 14, wherein the opportunity comprises a chance to obtain a special game power.

38. The method of claim 14, further comprising the step of determining a player rank, wherein the opportunity is based, at least in part, on the player rank.

39. The method of claim 14, further comprising:
determining first through N^{th} probabilities that the collectible will have first through N^{th} corresponding values; and
assigning the probabilities and the values to the collectible.

40. The method of claim 14, further comprising:
determining first through N^{th} times during which that the collectible will have first through N^{th} corresponding values; and
assigning the times and the values to the collectible.

41. The method of claim 18, wherein the machine-readable medium comprises a ticket.

42. The method of claim 20, wherein a player can interact with a collectible to change a state of the collectible.

43. The method of claim 22, wherein the predetermined threshold comprises a point threshold of a player tracking program.

44. The method of claim 30, wherein the risk comprises a risk regarding a value of the collectible.

45. The method of claim 37, wherein the special game power comprises an advantage in game play.

46. The method of claim 41, wherein the ticket is readable by a gaming machine or a kiosk.

47. The method of claim 41, wherein the ticket is redeemable only by a participating gaming machine or a participating kiosk.

48. The method of claim 42, wherein a state change of a collectible in response to a player's interaction is not completely predictable.

49. The method of claim 45, wherein the advantage in game play comprises a temporary advantage in game play.

50. The method of claim 48, wherein a player's interaction may produce either positive or negative results.

51. A gaming network, comprising:
a gaming machine configured for providing wagering games during a first gaming session;
means for awarding at least one collectible upon the occurrence of an event during the first gaming session;
means for offering to redeem one or more collectibles in exchange for an opportunity involving wagering game play; and
means for causing unredeemed collectibles awarded to members of a player loyalty program to persist after the first gaming session.

52. The gaming network of claim 51, further comprising means for causing unredeemed collectibles awarded to non-members of a player loyalty program to persist after the first gaming session.

53. A gaming method, comprising:
receiving a data structure comprising image data;
extracting the image data;
associating the image data with virtual tokens;
providing a wagering game;
awarding at least one virtual token upon an occurrence of an event during the wagering game; and
offering to redeem one or more virtual tokens in exchange for an opportunity involving the wagering game.

54. The method of claim 53, wherein the image data are associated with a gaming establishment.

55. The method of claim 53, wherein the awarding step comprises displaying a virtual token on a display of a gaming machine.
